(19) United States
(12) Patent Application Publication
(10) Pub. No.: US 2024/0413550 A1
(43) Pub. Date: Dec. 12, 2024

(54) FULLY SYMMETRIC SOCKET PIN ARRANGEMENT

(71) Applicant: Intel Corporation, Santa Clara, CA (US)

(72) Inventors: Chenghai Yan, Shanghai (CN); Wenzhi Wang, Shanghai (CN); Qihang Shang, Shanghai (CN); Tao Xu, Shanghai (CN); Weijiao Jiang, Shanghai (CN); Xinjun Zhang, Shanghai (CN); Lei Wang, Shanghai (CN); Xiaorui Xu, Shanghai (CN)

(21) Appl. No.: 18/805,632

(22) Filed: Aug. 15, 2024

Related U.S. Application Data
(63) Continuation of application No. PCT/CN2022/089225, filed on Apr. 26, 2022.

(51) Int. Cl. H01R 12/70; H01R 13/6461

(52) U.S. Cl. CPC H01R 12/7076; H01R 13/6461

(57) ABSTRACT

An apparatus and method for reducing differential cross-talk in a CPU pin arrangement of a server motherboard are described. The CPU pin arrangement has pin patterns that are arranged in a square, separated from each other, and are mirrored around an axis between the pin patterns. Each pin pattern has pins that each include a main body with a lateral asymmetric cross-section, a first connector extending from one end of the main body and coupled to the motherboard through solder, and a second connector extending from an opposing end of the main body and coupled to the CPU through a pressure contact.

This application is a continuation of and claims priority to International Application No. PCT/CN2022/089225, filed on Apr. 26, 2022, and published in English on Nov. 2, 2023 as WO 2023/206061 A1, which is incorporated herein by reference in its entirety.

### TECHNICAL FIELD

Embodiments pertain to server systems. In particular, some embodiments relate to improved signal integrity (SI) performance in CPU pin arrangements in server motherboards.

### BACKGROUND

In a server system, devices are disposed in a predetermined arrangement that is matched by the CPU pin arrangement in landing grid array (LGA) sockets. However, the SI performance of the pin arrangement differs dependent on the location due to the asymmetric structure of the LGA pins.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 illustrates a block diagram of a communication device in accordance with some embodiments.

FIG. 2A illustrates a server system in accordance with accordance with some embodiments.

FIG. 2B illustrates a pin map of the central processing unit (CPU) of FIG. 2A in accordance with some embodiments.

FIG. 2C illustrates a pin arrangement of the top portion of the CPU of FIG. 2A in accordance with some embodiments.

FIG. 2D illustrates another pin arrangement of the top portion of the CPU of FIG. 2A in accordance with some embodiments.

FIG. 2E illustrates a pin arrangement of the CPU of FIG. 2A in accordance with some embodiments.

FIG. 2F illustrates another pin arrangement of the CPU of FIG. 2A in accordance with some embodiments.

FIG. 3A illustrates a crosstalk heat map of the pin arrangement of FIG. 2C according to some embodiments.

FIG. 3B illustrates a crosstalk heat map of the pin arrangement of FIG. 2D according to some embodiments.

FIG. 4A illustrates a side view of a landing grid array (LGA) socket pin according to some embodiments.

FIG. 4B illustrates a top cross-sectional view of the main body of the LGA socket pin according to some embodiments.

FIG. 5A illustrates a pin pattern according to some embodiments.

FIG. 5B illustrates another pin pattern according to some embodiments.

FIG. 6A illustrates individual crosstalk for the pin pattern of FIG. 5A according to some embodiments.

FIG. 6B illustrates individual crosstalk for the pin pattern of FIG. 5B according to some embodiments.

FIG. 6C illustrates differential crosstalk for the pin pattern of FIGS. 5A and 5B according to some embodiments.

FIG. 7 illustrates a method of fabricating the server system according to some embodiments.

FIG. 8A illustrates a socket according to some embodiments.

FIG. 8B illustrates an enhanced view of the socket of FIG. 8A according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

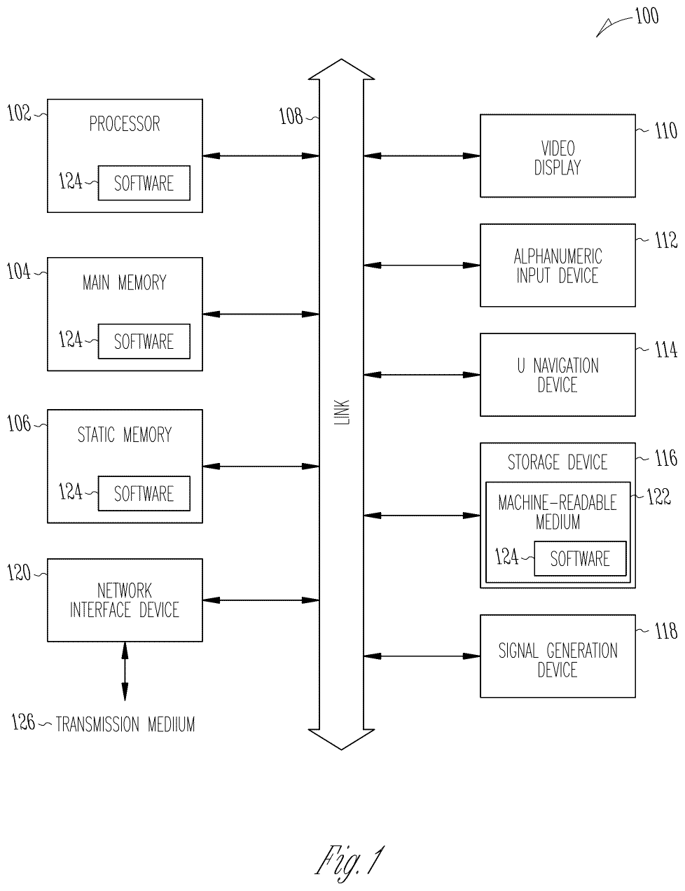

FIG. 1 illustrates a block diagram of a communication device in accordance with some embodiments. The communication device 100 may be a user equipment (UE) such as a specialized computer, a personal or laptop computer (PC), a tablet PC, or a smart phone, or network equipment such as an NodeB, a server running software to configure the server to, e.g., operate as a network device, or any machine capable of executing instructions (sequential or otherwise) that specify actions to be taken by that machine. Note that although FIG. 1 is shown as a communication device, the embodiments described herein may apply to any electronic device that uses a circuit board.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 100 may include a hardware processor (or equivalently processing circuitry) 102 (e.g., a central processing unit (CPU), a GPU, a hardware processor core, or any combination thereof), a main memory 104 and a static memory 106, some or all of which may communicate with each other via an interlink (e.g., bus) 108. The main memory 104 may contain any or all of removable storage and non-removable storage, volatile memory or non-volatile memory. The communication device 100 may further include a display unit 110 such as a video display, an alphanumeric input device 112 (e.g., a keyboard), and a user interface (UI) navigation device 114 (e.g., a mouse). In an example, the display unit 110, input device 112 and UI navigation device 114 may be a touch screen display. The communication device 100 may additionally include a storage device (e.g., drive unit) 116, a signal generation device 118 (e.g., a speaker), a network interface device 120, and one or more sensors, such as a global positioning system (GPS) sensor, compass, accelerometer, or other sensor. The communication device 100 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 116 may include a non-transitory machine readable medium 122 (hereinafter simply referred to as machine readable medium) on which is stored one or more sets of data structures or instructions 124 (e.g., software) embodying or utilized by any one or more of the techniques or functions described herein. The instructions 124 may also reside, completely or at least partially, within the main memory 104, within static memory 106, and/or within the hardware processor 102 during execution thereof by the communication device 100. While the machine readable medium 122 is illustrated as a single medium, the term “machine readable medium” may include a single medium or multiple media (e.g., a centralized or distributed database, and/or associated caches and servers) configured to store the one or more instructions 124.

The term “machine readable medium” may include any medium that is capable of storing, encoding, or carrying instructions for execution by the communication device 100 and that cause the communication device 100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 124 may further be transmitted or received over a communications network using a transmission medium 126 via the network interface device 120 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks. Communications over the networks may include one or more different protocols, such as Institute of Electrical and Electronics Engineers (IEEE) 802.11 family of standards known as Wi-Fi, a Long Term Evolution (LTE) family of standards, a Universal Mobile Telecommunications System (UMTS) family of standards, peer-to-peer (P2P) networks, and a next generation (NG)/5^{th} generation (5G) standards, among others. In an example, the network interface device 120 may include one or more physical jacks (e.g., Ethernet, coaxial, or phone jacks) or one or more antennas to connect to the transmission medium 126.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (such as 4G, 5G, or 6G), Zigbee, Bluetooth, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V21) and Infrastructure-to-Vehicle (12V) communication technologies, 3GPP cellular V2X, or DSRC (Dedicated Short Range Communications) communication systems such as Intelligent-Transport-Systems and others.

Aspects described herein can be used in the context of any spectrum management scheme including dedicated licensed spectrum, unlicensed spectrum, license exempt spectrum, (licensed) shared spectrum. Applicable spectrum bands include the IMT spectrum as well as other types of spectrum/bands, such as bands with national allocation, spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), Intelligent Transport Systems (ITS) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as Program Making and Special Events (PMSE), medical, health, surgery, automotive, low-latency, drones, etc. applications.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources. Some of the features are defined for the network side, such as APs, eNBs, NR or gNBs-note that this term is typically used in the context of 3GPP 5G and 6G communication systems, etc. Still, a UE may take this role as well and act as an AP, eNB, or gNB; that is some or all features defined for network equipment may be implemented by a UE.

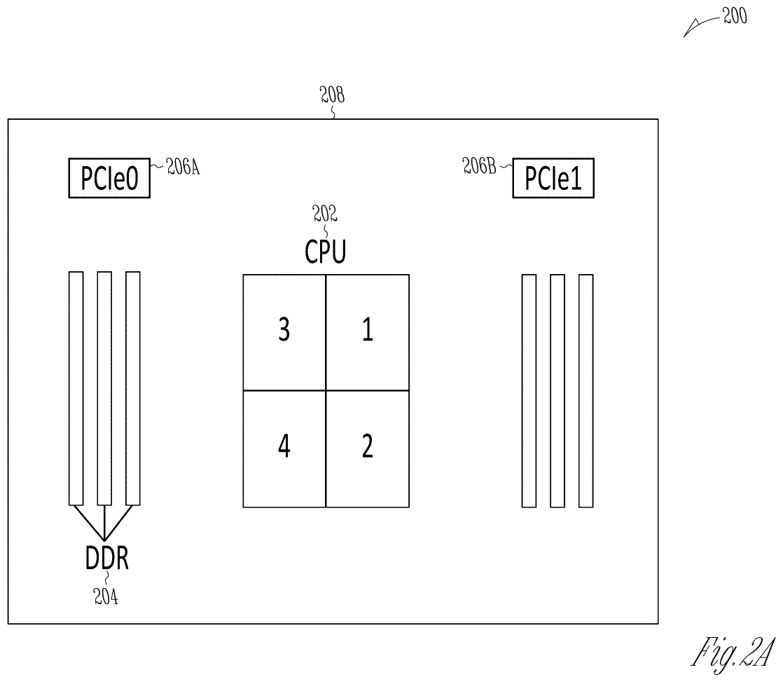

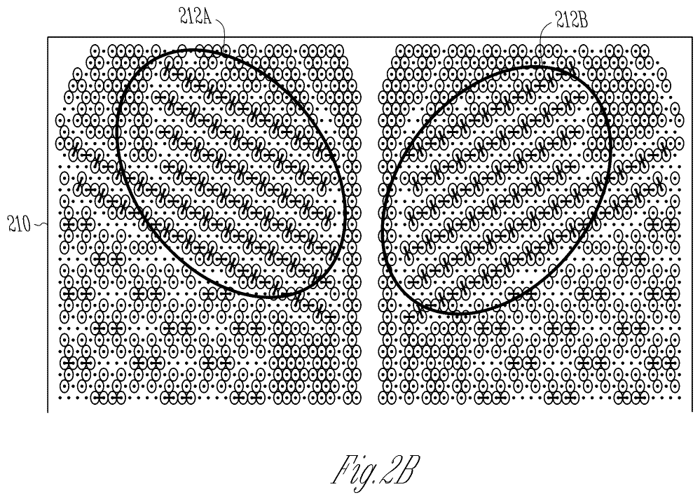

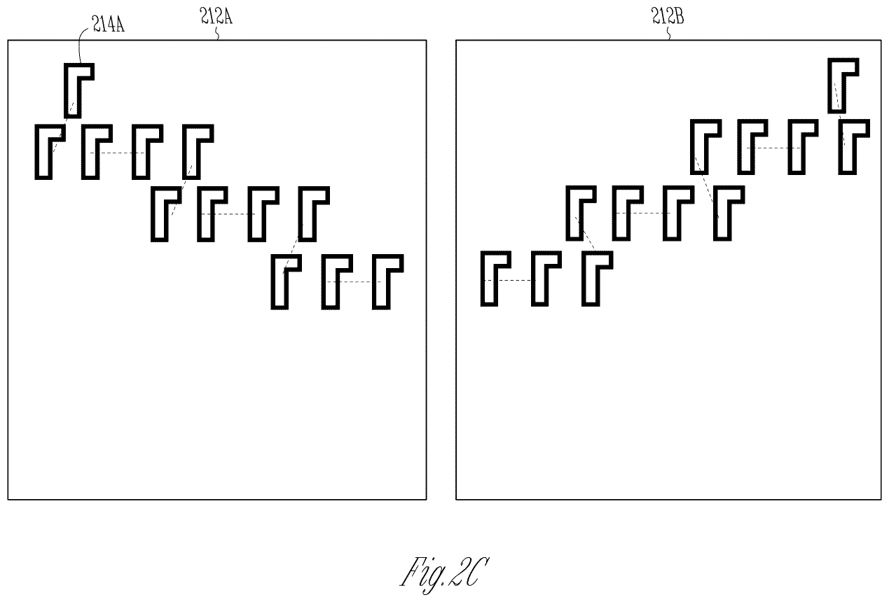

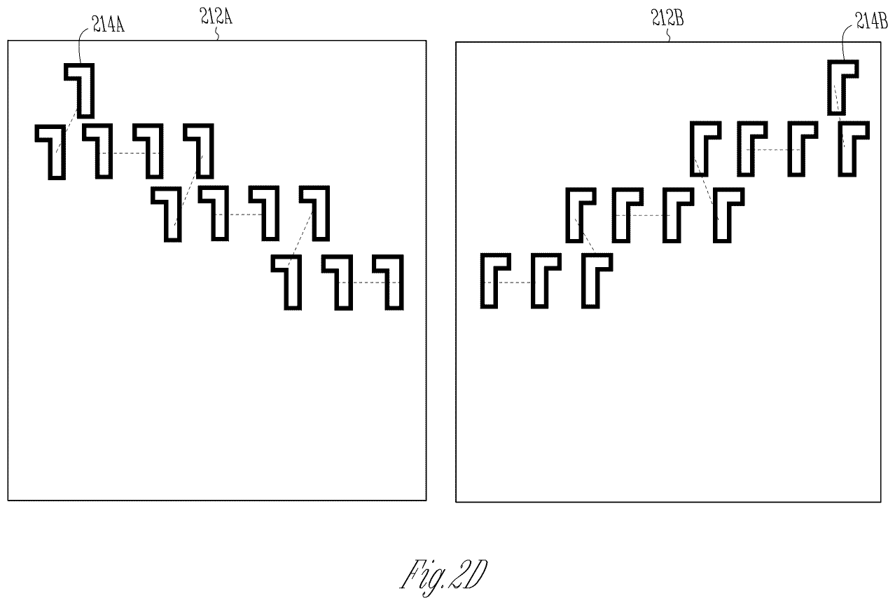

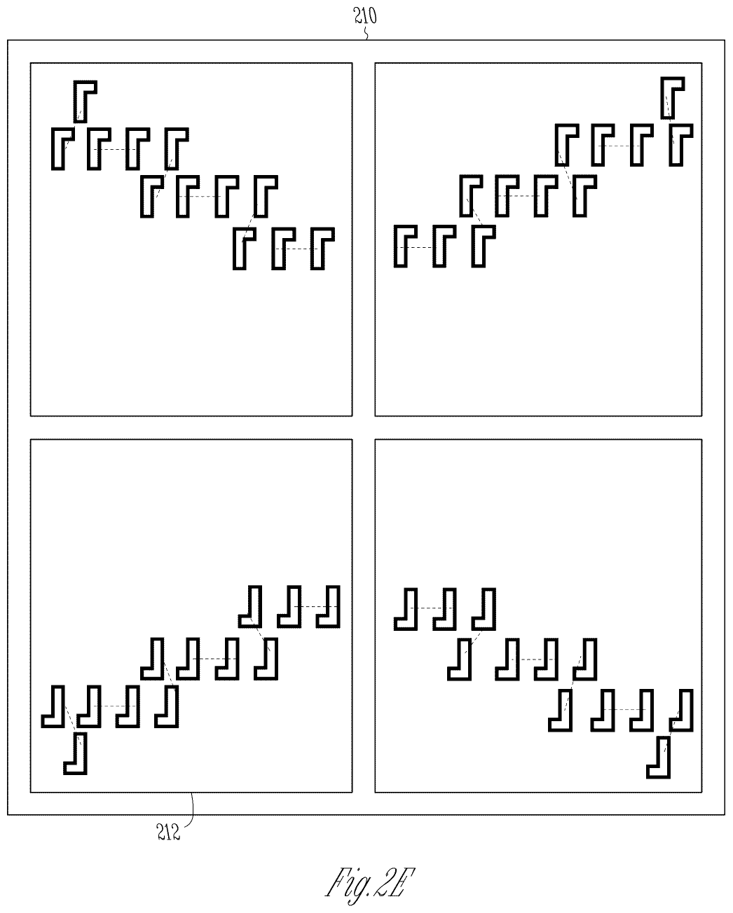

In other embodiments, the embodiments described herein may be used in a server system. In particular, FIG. 2A illustrates a server system in accordance with some embodiments. The server system 200 contains a number of devices, only some of which are shown in FIG. 2A for convenience. In one example, the server system 200 includes a CPU pin arrangement to which a CPU 202 is connected, multiple RAM memory slots to which RAM memory 204 is connected and Peripheral Component Interconnect Express (PCIe) slots 206a, 206b for connections to various components of a printed circuit board (PCB) 208 to which the CPU 202 and RAM memory 204 are connected. The PCB 208 may be single or double sided, multilayered, flexible and/or rigid, among others.

The RAM memory 204 may include a number of Dual In-line Memory Modules (DIMMs), as shown Double Data Rate (DDR) DIMMs. The DIMMs include a number of memory components attached to a circuit board (not shown) with pins to provide a connection between the DIMMs and a socket on a motherboard. Other types of DIMMs may be used-for example, Small Outline DIMMs (SODIMMs) or MicroDIMMs, or Double Data Rate2/3/4 (DDR2/DDR3/DDR4/DDR5) type DIMMs may be used. The DIMMs may be used to provide Synchronous Dynamic Random Access Memory (SDRAM) for the CPU 202.

As shown in FIG. 2A, the devices (e.g., DDR DIMMs 204 in the RAM memory slots and elements in the PCIE slots 206a, 206b) are usually symmetrically placed in the server system 200. In particular, FIG. 2A shows a left-right symmetric placement of the devices centered around a center of the CPU 202. To match the placement of the devices, the CPU pins may also be symmetrically arranged. The CPU pin map can be divided into multiple regions, specifically as shown in in FIG. 2A, four although other numbers of regions may be used (e.g., 2). FIG. 2B illustrates a pin map of the top portion of the CPU of FIG. 2A in accordance with some embodiments. In particular, as shown by the pin arrangement 210, the left-hand side pin pattern 212a is almost symmetric to the right-hand side pin pattern 212b. The pin patterns 212a, 212b are segmented, separated by a vertical axis therebetween (each of the vertical axis and horizontal axis shown may be considered to be a main axis).

For such a symmetric pin map, the signal integrity (SI) performance of the left-hand side pins is assumed the same as the right-hand side pins. However, this is not the case for LGA sockets, which are widely used in server platforms. The SI performance of one side can be significantly worse than the other side because of the asymmetric structure of the LGA pins.

FIG. 2C illustrates a pin arrangement of the top portion of the CPU of FIG. 2A in accordance with some embodiments. As illustrated, the first set of LGA pins 214a is disposed in rows (only one of which is shown in FIG. 2C) and is replicated on both the right side (region 3 in FIG. 2A) and left side (region 1 in FIG. 2A)-the left-hand side pin pattern 212a is almost symmetric to the right-hand side pin pattern 212b. Although shown as rows, the sets of LGA pins 214a may be arranged in other embodiments in patterns other than the rows shown. Pairs of the LGA pins 214a are coupled; the coupling between specific differential pairs of the LGA pins 214a is shown by dotted lines in FIG. 2C (as in other figures). The crosstalk of region 1 is asymmetric to region 3 (in a similar manner, the crosstalk of region 2 is asymmetric to region 4) because of the asymmetric structure of the LGA socket pins 214a (shown as having an L-like shaped cross-section), with the upper portion of the LGA pins 214a extending from the base of the LGA pins 214a in the same direction in both regions. The crosstalk is single-ended far-end crosstalk (in which one of the coupled pins carries the positive signal and the other carries the negative signal, and the measured crosstalk is at an opposite end than where the signal was sent). Because of the asymmetric structure, the crosstalk among surrounding LGA pins 214a is different. As a result, even though the pin map 212a, 212B looks symmetric, the crosstalk is different. This difference is either absorbed in the channel margin, which results in a smaller, degraded channel margin, or a different pin pattern that generally uses more pins is applied on the side whose crosstalk is worse. The use of a different pin pattern increases the difficulty of the PCB fan-out (the traces from the device lands to an adjacent via), and increases the number of pins. FIG. 2E illustrates a pin arrangement 210 for the CPU of FIG. 2A in accordance with some embodiments. That is, FIG. 2E illustrates the entire pin arrangement 210 with pin patterns 212 of regions 1-4, including the pin patterns 212a, 212b shown in FIG. 2C. As can be seen, the pins in a particular pin pattern 212 have the same shape and are oriented in the same manner (that is, the lateral cross-section of the main body have the same overall shape, as described in more detail below). As used herein, adjacent pin patterns 212 are pin patterns 212 that are horizontally or vertically adjacent (e.g., 1 and 2 or 3), but not diagonally adjacent (e.g., 1 and 4). The pins in horizonally adjacent pin patterns 212 are also oriented in the same manner, while the pins in vertically adjacent pin patterns 212 are rotated 180 degrees from each other (that the pin patterns 212a, 212b are asymmetric to each other).

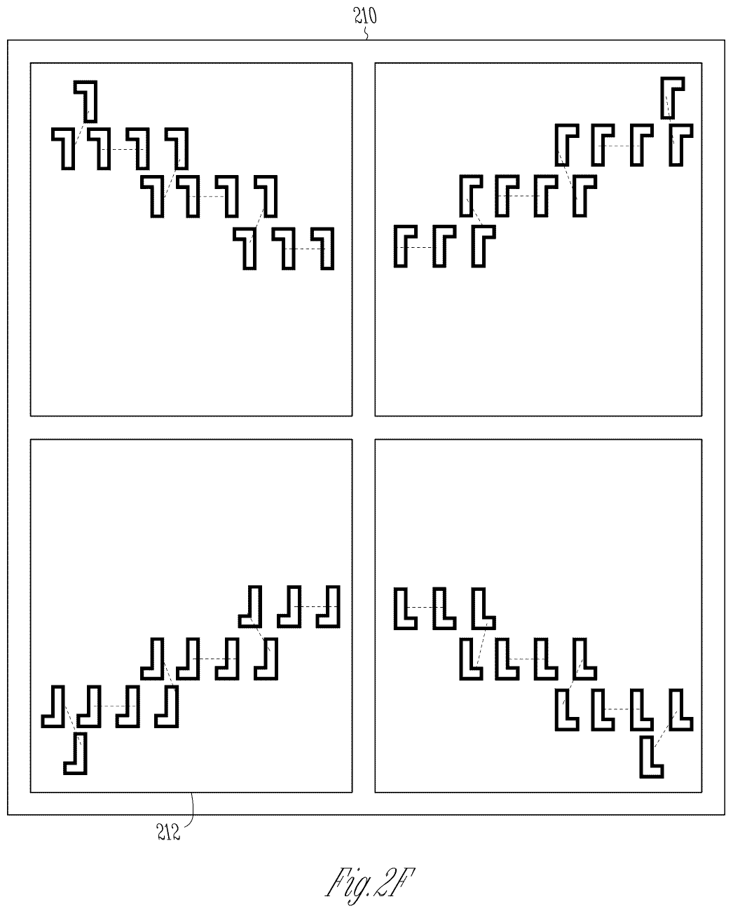

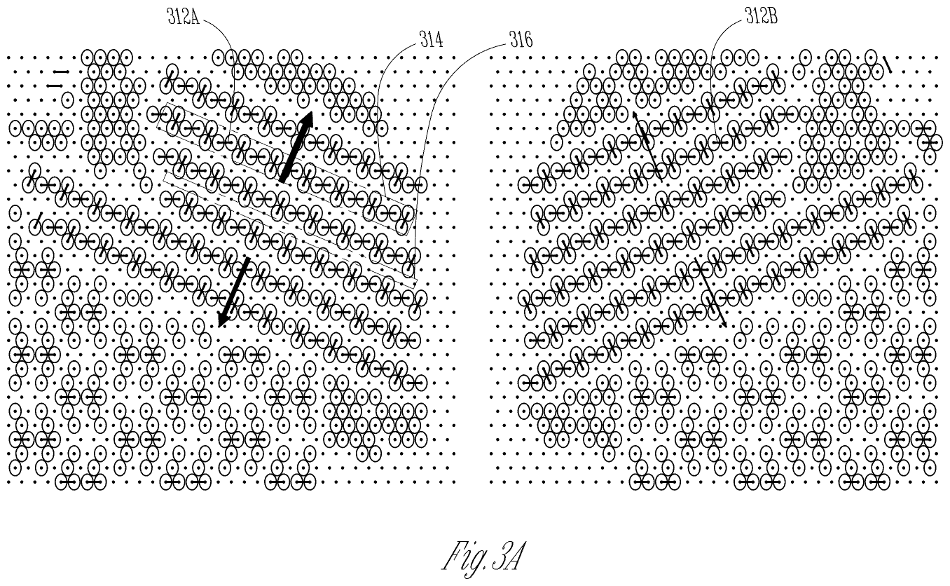

FIG. 3A illustrates a crosstalk heat map of the pin arrangement of FIG. 2C according to some embodiments. In FIG. 3A, the warmer the color of one LGA pin 214a (shown by the thicker lines on the left hand side of FIG. 3A), the more crosstalk the pin 312a, 312b suffers from its adjacent LGA pins 214a. A row of LGA pins 314 indicated in FIG. 3A is the same as the rows shown in FIGS. 2A-2F. A row of ground pins 316 is disposed between adjacent rows of LGA pins 314. Each row of LGA pins 314 has pairs of pins that provide a differential voltage. The direction of decreasing crosstalk within each side is shown by the arrows in FIG. 3A. As indicated, the left-hand side of FIG. 3A has a higher amount of crosstalk than the right-hand side.

FIG. 2D illustrates another pin arrangement of the top portion of the CPU of FIG. 2A in accordance with some embodiments. In particular, FIG. 2D illustrates a fully symmetric pin arrangement 210 between the left-hand side LGA pins 214a and right-hand side LGA pins 214B in the pin patterns 212. As shown, the left-hand side LGA pins 214a and right-hand side LGA pins 214B are mirrored; the upper portion of the left-hand side LGA pins 214a extend from the base of the left-hand side LGA pins 214a in the opposite direction than that of the upper portion of the right-hand side LGA pins 214B from the base of the right-hand side LGA pins 214B. FIG. 2F illustrates a pin arrangement of the CPU of FIG. 2A in accordance with some embodiments. That is, FIG. 2F illustrates the entire pin arrangement of regions 1-4, including the arrangement shown in FIG. 2D. Similar to FIG. 2E, the pins in a particular pin pattern 212 have the same shape and are oriented in the same manner. The pins in horizonally adjacent pin patterns 212 are oriented in a mirror manner from each other (i.e., mirrored around the vertical axis), and the pins in vertically adjacent pin patterns 212 are oriented in a mirror manner from each other (i.e., mirrored around the horizontal axis). Note that like FIG. 2E, only some of the pins in the pin patterns 212 are shown in FIG. 2F. The term “axis” may be relative to the space between the regions, relative to the socket in which the pin arrangement is disposed, or both.

FIG. 3B illustrates a crosstalk heat map of the pin arrangement of FIG. 2D according to some embodiments. The corresponding crosstalk heat map 312c is similar on both sides and has been improved by about 6 dB.

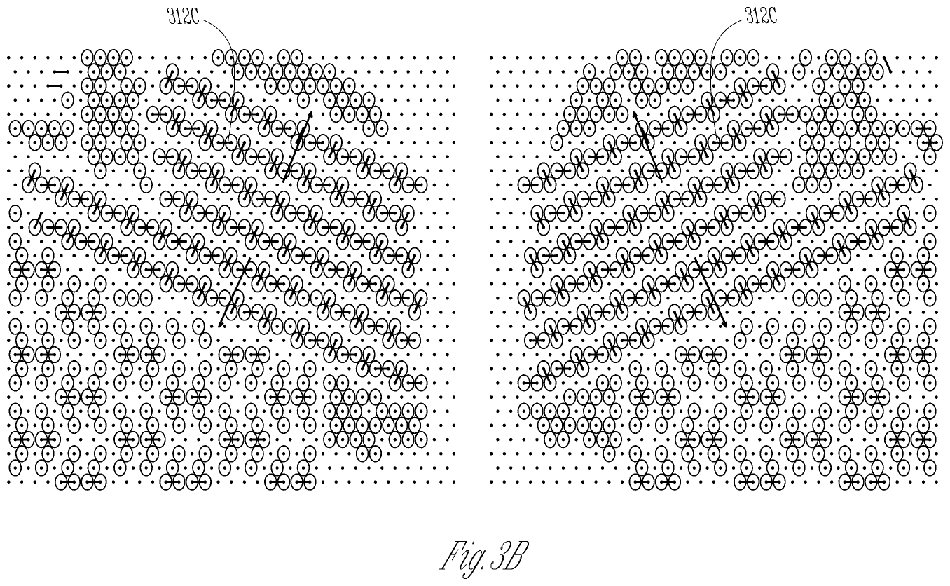

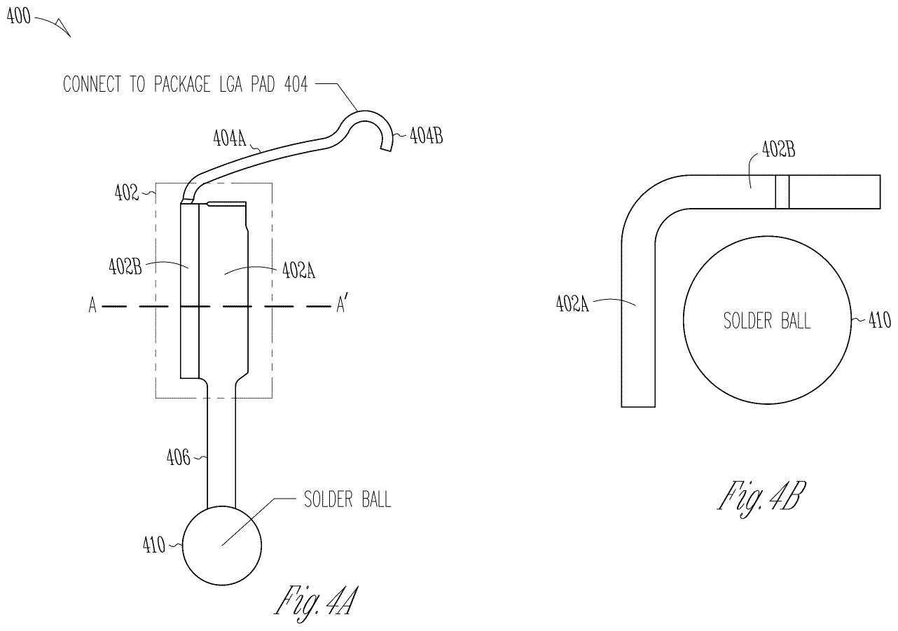

FIG. 4A illustrates a side view of a LGA socket pin according to some embodiments. The LGA socket pin 400 is formed from a flexible conductive material, such as metal. The LGA socket pin 400 includes a main body 402, a pad connector 404, and a PCB connector 406. The pad connector 404 is configured to contact to a device package, in particular a specific contact LGA contact pad. The pad connector 404 may have any shape to connect to the device package. As shown, the pad connector 404 includes an arm 404a and a hook 404b at the end of the arm 404a. The arm 404a is coupled to the main body 402. The hook 404b is configured to make pressure contact with the pad of the CPU package.

FIG. 4B illustrates a top cross-sectional view of the main body of the LGA socket pin according to some embodiments. The lateral cross-sectional view is taken along line A-A′ in FIG. 4A. The main body 402 of the LGA socket pin 400 includes a single conductive material bent into two substantially perpendicular sides 402a, 402b, one of which is coupled to the arm 404a. Thus, the main body 402 is substantially L-shaped. The arm 404a is coupled to one of the main body sides 402b. The other of the main body sides 402a is coupled to the PCB connector 406. In particular, the PCB connector 406 is soldered to the PCB (or other electronic component, such as an interposer) via a solder ball 410, although other types of electrical connection may be used (e.g., wires, solder bump, pads). The LGA socket pin 400 thus connects to a (underlying) electronic circuit (which may be on/in the PCB) through the PCB connector 406. The main body 402 has the strongest coupling and contributes most of the crosstalk.

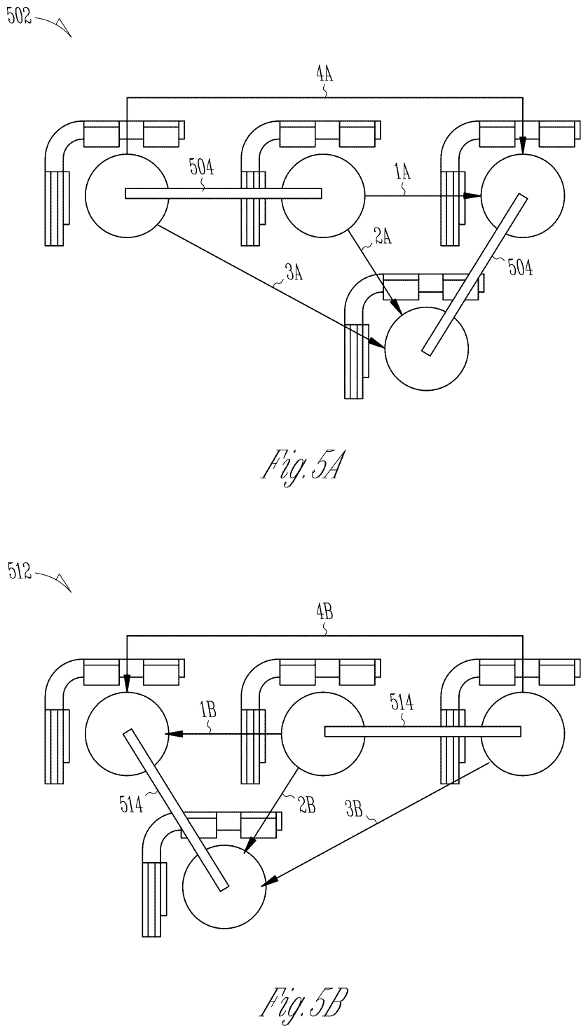

FIG. 5A illustrates a pin pattern according to some embodiments. FIG. 5B illustrates another pin pattern according to some embodiments. The first pin pattern 502 of FIG. 5A is a portion of one of rows of LGA pins on the left side of the pin map shown in FIG. 2B; the second pin pattern 512 of FIG. 5B is a portion one of rows of LGA pins in the right side of the pin map shown in FIG. 2B. The line 504 in FIG. 5A and line 514 in FIG. 5B indicate the differential pairs of LGA pins, which dominate the crosstalk. Thus, as shown in FIGS. 5A and 5B, each row of LGA pins includes multiple horizontal lines of LGA pins, and each horizontal line includes four LGA pins, two of which form a differential pair and two of which form a differential pair with an LGA pin in an adjacent horizontal line (one in a horizontal line above and one in a horizontal line below).

According to scattering parameter (s-parameter) theory, the differential crosstalk however can be expressed as Equation 1:

$${S}_{diff} = 0.5 * ( ( s 1 - s 2 ) + ( s 3 - s 4 ) ) \qquad ( 1 )$$

Where s1, s2, s3, and s4 are shown in FIGS. 5A and 5B as crosstalk 1a/1b, . . . etc.

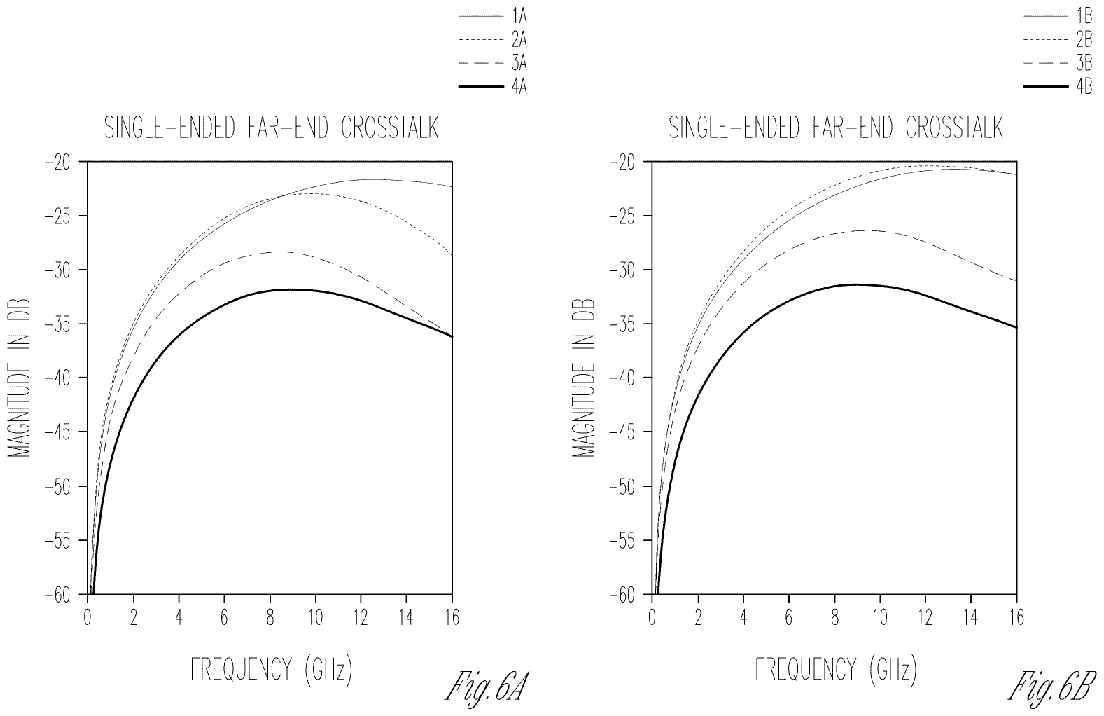

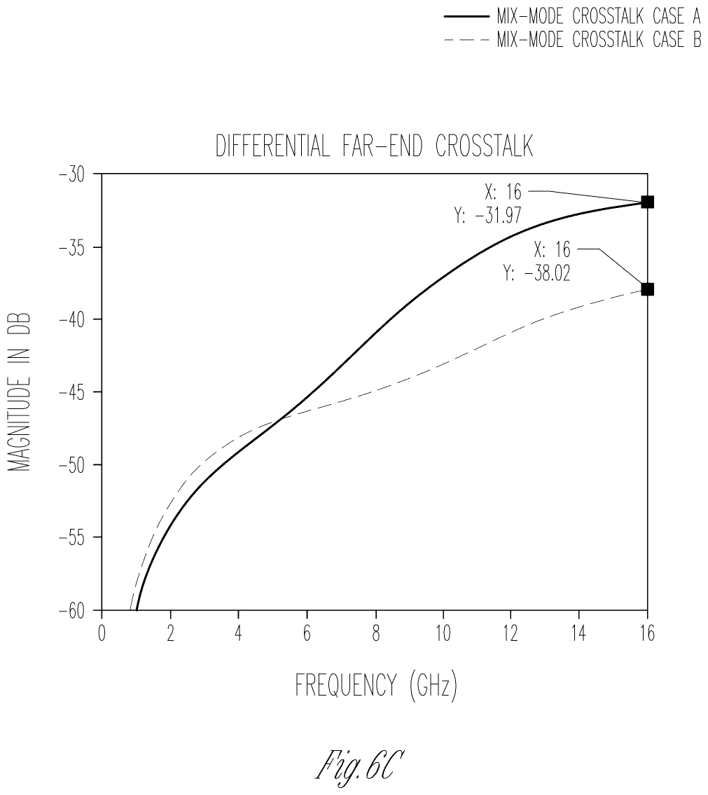

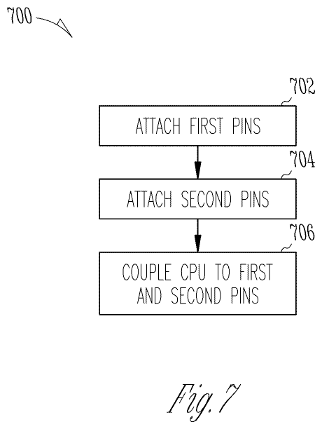

Both the individual and differential crosstalk for the different pin pattern are provided, the crosstalk is based on the average distance between the various LGA pins. In particular, FIG. 6A illustrates individual crosstalk for the pin pattern of FIG. 5A according to some embodiments. FIG. 6B illustrates individual crosstalk for the pin pattern of FIG. 5B according to some embodiments. FIG. 6C illustrates differential crosstalk for the pin pattern of FIGS. 5A and 5B according to some embodiments. According to Equation 1, the differential crosstalk is decided by the difference between individual crosstalk 1 and 2, as well as crosstalk 3 and 4 shown in FIGS. 5A and 5B (e.g., crosstalk 1a and 2a in FIG. 5A). As shown in FIG. 5A, the distance between two socket main bodies of crosstalk 2a is farther than the distance between the two socket main bodies of crosstalk 1a. As a result, as illustrated in the graph of FIG. 6A, while crosstalk la and crosstalk 2a are relatively the same at lower frequencies, crosstalk 2a diverges from crosstalk 1a at about 10 GHz, becoming increasingly smaller than that of crosstalk la at frequencies increasingly greater than 10 GHz.

In contrast, as shown in FIG. 5B, the distance between two socket main bodies of crosstalk 2a is similar to the distance between the two socket main bodies of crosstalk 1a. This results in crosstalk 1a and 2a remaining approximately the same over the entire frequency range up to 16 GHz, as shown in FIG. 5B.

The distance between the two socket main bodies of crosstalk 3a and crosstalk 4a in FIG. 5A are similar, which results in the difference in crosstalk between crosstalk 3a and crosstalk 4a decreasing with increasing frequency to 16 GHz. This results in a differential crosstalk that is primarily dominated by the difference between crosstalk 3a and crosstalk 4a at frequencies less than about 12 GHz and by crosstalk 1a and crosstalk 2a at frequencies greater than about 12 GHz. Similarly, the distance between the two socket main bodies of crosstalk 3b and crosstalk 4b in FIG. 5B results in a difference in crosstalk that dominates over all frequency ranges, increasing from about 6 GHz to 16 GHz. That is the average distance between an end pin coupled to a pin of a lower line and a middle pin adjacent to the end pin (i.e., no pin therebetween), and between the middle pin and the pin of the lower line are about the same. The increasing divergence results in the differential crosstalk in both cases increasing with frequency as shown in FIG. 6C, albeit at a slower rate from about 6 GHz to 16 GHz in the pin pattern of FIG. 5B than that of FIG. 5A. In particular, as shown, the differential crosstalk between the pin patterns of FIGS. 5A and 5B has about 6 dB difference at 16 GHz. A 6 dB difference decreases the magnitude of the crosstalk by a factor of 2. This translates to an approximately 1 inch solution space extension of PCIe Gen5 with ultra-low loss category one (ULL1) material. In such a pin arrangement, the pin patterns and the pin geometry for both for the left-hand side and right-hand side pins are symmetric. This leads to the SI performance of the two sides becoming identical.

Accordingly, a symmetric (mirrored) pin arrangement as shown in FIG. 3B may be used to reduce the magnitude of the crosstalk. As a result, the crosstalk is improved about 6 dB at 16 GHz compared with a non-symmetric pin arrangement. This improves the performance of PCIe Gen5 sockets, which as above, are able to operate at up to about 16 GHz. Note that although LGA sockets and LGA socket pins are described, in other embodiments any type of sockets and pins may take advantage of the symmetric and mirrored pin arrangement for pins that have one or more axes of symmetry around which a reflection may be used.

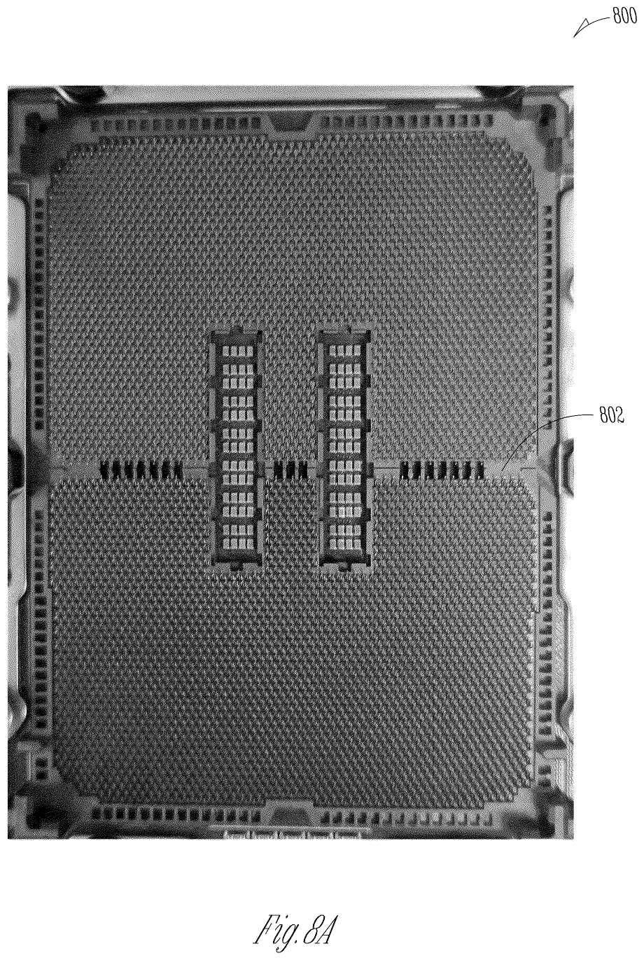

FIG. 7 illustrates a method of fabricating the server system according to some embodiments. The method 700 of FIG. 7 only provides operations related to the socket pin arrangement pin arrangement coupled to the motherboard (PCB) described above; additional operations may be present, including operations related to fabricating PCIe and/or DIMMs slots, as well as attaching various components to the motherboard. At operation 702, a first set of pins are attached to the motherboard. The first set of pins may be provided in different pin patterns in the overall CPU pin arrangement shown in FIG. 2F. In particular, the first set of pins may be attached to the motherboard in diagonally opposed pin patterns shown in FIG. 2F ((1 and 4) or (2 and 3) in FIG. 2A). The first set of pins may be rotated 180 degrees from each other before being attached to the motherboard in the diagonally opposed pin patterns.

At operation 704, a second set of pins are attached to the motherboard. The first and second set of pins may be simultaneously attached to the motherboard. The second set of pins may be provided in the remaining diagonal pin patterns in the overall CPU pin arrangement. Like the first set of pins, the second set of pins may be rotated 180 degrees from each other before being attached to the motherboard in the other diagonally opposed pin patterns. This result in adjacent pin patterns that are mirrored rather than being rotated. Although the contacts of first and second set of pins (to the motherboard and CPU) may be the same, the lateral cross-sections are mirrored rather than being rotated, resulting in different pins being fabricated for the diagonally opposed pin patterns. The first and second sets of pins may be attached to the motherboard at lower ends of the pins using solder, for example. The first and second sets of pins may be fabricated by, e.g., stamping the conductive material and then bending the stamped conductive material into the desired shape.

After the first and second sets of pins have been attached to the motherboard, the CPU can then be attached at operation 706. The CPU may be coupled to the first and second sets of pins through a socket or interposer, for example.

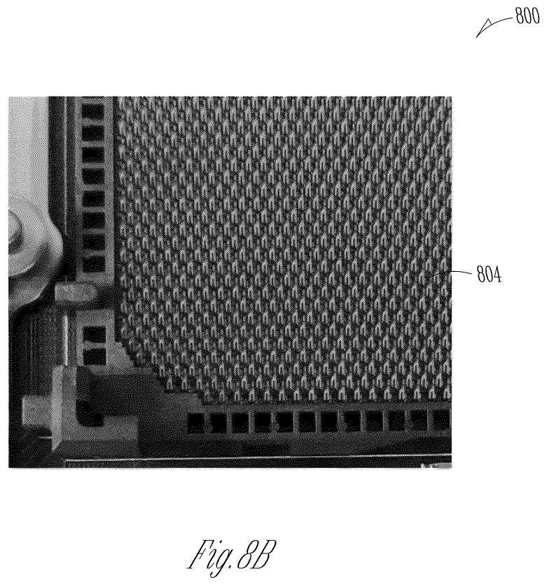

FIG. 8A illustrates a socket according to some embodiments. FIG. 8B illustrates an enhanced view of the socket of FIG. 8A according to some embodiments. The socket 800 includes a housing 802 and pins 804. The housing 802 may be formed from a non-conductive material such as plastic, for example.

### EXAMPLES

Example 1 is an apparatus for a socket, the apparatus comprising: a pin arrangement including a plurality of segmented pin patterns that are separated from each other by an axis disposed therebetween, each pin pattern having a plurality of pins, each pin including main body having a lateral asymmetric cross-section that has a same shape as other pins, the pin patterns being symmetrical around the axis.

In Example 2, the subject matter of Example 1 includes that the pin arrangement comprises four pin patterns arranged in a square.

In Example 3, the subject matter of Example 2 includes that each pin pattern is mirrored from adjacent pin patterns by one of multiple orthogonal axes that separate the pin pattern from the adjacent pin patterns.

In Example 4, the subject matter of Examples 1-3 includes that each pin further includes: a first connector extending from one end of the main body and configured to make electrical contact to an electronic circuit, and a second connector extending from an opposing end of the main body and configured to contact a contact pad.

In Example 5, the subject matter of Example 4 includes that the second connector includes an arm extending from the main body and a hook configured to contact the contact pad.

In Example 6, the subject matter of Examples 4-5 includes that the main body comprises perpendicular sides, the first connector extending from one of the perpendicular sides and the second connector extending from another of the perpendicular sides.

In Example 7, the subject matter of Examples 1-6 includes that the pins in each arrangement are formed in rows of pins, each row of pins includes multiple horizontal lines of pins, and each horizontal line includes four pins.

In Example 8, the subject matter of Example 7 includes that a first and second pin of the four pins of a particular horizontal line form a first differential pair, a third of the pins of the particular horizontal line forms a second differential pair with a pin of a horizontal line above the particular horizontal line, and a fourth of the pins of the particular horizontal line forms a third differential pair with a pin of a horizontal line below the particular horizontal line.

In Example 9, the subject matter of Example 8 includes that a first distance between the second and fourth pin is about equal to a second distance between the second pin and the pin of the horizontal line below the particular horizontal line, the second and fourth pin being adjacent.

In Example 10, the subject matter of Examples 1-9 includes that the main body has a substantially “L” shape.

In Example 11, the subject matter of Examples 1-10 includes that the pins are landing grid array (LGA) pins.

Example 12 is an apparatus for a printed circuit board (PCB), the apparatus comprising: a central processing unit (CPU) pin arrangement configured to be coupled to a CPU and having a pin arrangement including a plurality of segmented pin patterns that are separated from each other by an axis disposed therebetween, each pin pattern having a plurality of pins, each pin including: a main body having a lateral asymmetric cross-section, the pin patterns being mirrored around the axis, a first connector extending from one end of the main body and coupled to the PCB through solder, and a second connector extending from an opposing end of the main body and configured to contact a contact pad of the CPU.

In Example 13, the subject matter of Example 12 includes that: the pin arrangement comprises four pin patterns arranged in a square, and each pin pattern is mirrored from adjacent pin patterns by one of multiple orthogonal axes that separate the pin pattern from the adjacent pin patterns.

In Example 14, the subject matter of Examples 12-13 includes that the main body comprises perpendicular sides, the first connector extending from one of the perpendicular sides and the second connector extending from another of the perpendicular sides.

In Example 15, the subject matter of Example 14 includes that the main body has a substantially “L” shape.

In Example 16, the subject matter of Examples 1-15 includes that the pins in each arrangement are formed in rows of pins, each row of pins includes multiple horizontal lines of pins, and each horizontal line includes four pins.

In Example 17, the subject matter of Example 16 includes that a first and second pin of the four pins of a particular horizontal line form a first differential pair, a third of the pins of the particular horizontal line forms a second differential pair with a pin of a horizontal line above the particular horizontal line, and a fourth of the pins of the particular horizontal line forms a third differential pair with a pin of a horizontal line below the particular horizontal line.

In Example 18, the subject matter of Example 17 includes that a first distance between the second and fourth pin is about equal to a second distance between the second pin and the pin of the horizontal line below the particular horizontal line, the second and fourth pin being adjacent.

Example 19 is a method of fabricating a server motherboard, the method comprising: attaching a first set of pins in first diametrically opposed pin patterns of a central processing unit (CPU) pin arrangement of the server motherboard, the first set of pins in one of the first diametrically opposed pin patterns being rotated 180 degrees from another of the first diametrically opposed pin patterns; and attaching a second set of pins in second diametrically opposed pin patterns of the CPU pin arrangement, the second set of pins in one of the second diametrically opposed pin patterns being rotated 180 degrees from another of the second diametrically opposed pin pattern, the first and second set of pins being mirrored.

In Example 20, the subject matter of Example 19 includes that: each pin includes: a main body having a lateral asymmetric cross-section, a first connector extending from one end of the main body, and a second connector extending from an opposing end of the main body, the first connector terminating in a hook; and the method further comprises: soldering the first connectors to the motherboard; and making electrical contact between the second connectors and a CPU.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a socket, the apparatus comprising:
a pin arrangement including a plurality of segmented pin patterns that are separated from each other by an axis disposed therebetween, each pin pattern having a plurality of pins, each pin including main body having a lateral asymmetric cross-section that has a same shape as other pins, the pin patterns being symmetrical around the axis.

2. The apparatus of claim 1, wherein the pin arrangement comprises pin patterns arranged in a square.

3. The apparatus of claim 2, wherein each pin pattern is mirrored from adjacent pin patterns by one of multiple orthogonal axes that separate the pin pattern from the adjacent pin patterns.

4. The apparatus of claim 1, wherein each pin further includes:
a first connector extending from one end of the main body and configured to make electrical contact to an electronic circuit, and
a second connector extending from an opposing end of the main body and configured to contact a contact pad.

5. The apparatus of claim 4, wherein the second connector includes an arm extending from the main body and a hook configured to contact the contact pad.

6. The apparatus of claim 4, wherein the main body comprises perpendicular sides, the first connector extending from one of the perpendicular sides and the second connector extending from another of the perpendicular sides.

7. The apparatus of claim 1, wherein the pins in each arrangement are formed in rows of pins, each row of pins includes multiple horizontal lines of pins, and each horizontal line includes four pins.

8. The apparatus of claim 7, wherein a first and second pin of the four pins of a particular horizontal line form a first differential pair, a third of the pins of the particular horizontal line forms a second differential pair with a pin of a horizontal line above the particular horizontal line, and a fourth of the pins of the particular horizontal line forms a third differential pair with a pin of a horizontal line below the particular horizontal line.

9. The apparatus of claim 8, wherein a first distance between the second and fourth pin is about equal to a second distance between the second pin and the pin of the horizontal line below the particular horizontal line, the second and fourth pin being adjacent.

10. The apparatus of claim 1, wherein the main body has a substantially “L” shape.

11. The apparatus of claim 1, wherein the pins are landing grid array (LGA) pins.

12. An apparatus for a printed circuit board (PCB), the apparatus comprising:
a central processing unit (CPU) pin arrangement configured to be coupled to a CPU, the CPU pin arrangement including a plurality of segmented pin patterns that are separated from each other by an axis disposed therebetween, each pin pattern having a plurality of pins, each pin including:
a main body having a lateral asymmetric cross-section, the pin patterns being mirrored around the axis,
a first connector extending from one end of the main body and coupled to the PCB through solder, and
a second connector extending from an opposing end of the main body and configured to contact a contact pad of the CPU.

13. The apparatus of claim 12, wherein:
the CPU pin arrangement comprises multiple pin patterns arranged in a square, and
each pin pattern is mirrored from adjacent pin patterns by one of multiple orthogonal axes that separate the pin pattern from the adjacent pin patterns.

14. The apparatus of claim 12, wherein the main body comprises perpendicular sides, the first connector extending from one of the perpendicular sides and the second connector extending from another of the perpendicular sides.

15. The apparatus of claim 14, wherein the main body has a substantially “L” shape.

16. The apparatus of claim 12, wherein the pins in each pin pattern are formed in rows of pins, each row of pins includes multiple horizontal lines of pins, and each horizontal line includes at least four pins.

17. The apparatus of claim 16, wherein a first and second pin of the four pins of a particular horizontal line form a first differential pair, a third of the pins of the particular horizontal line forms a second differential pair with a pin of a horizontal line above the particular horizontal line, and a fourth of the pins of the particular horizontal line forms a third differential pair with a pin of a horizontal line below the particular horizontal line.

18. The apparatus of claim 17, wherein a first distance between the second and fourth pin is about equal to a second distance between the second pin and the pin of the horizontal line below the particular horizontal line, the second and fourth pin being adjacent.

19. A method of fabricating a server socket, the method comprising:
attaching a first set of pins in first diametrically opposed pin patterns of a central processing unit (CPU) pin arrangement of a server motherboard, the first set of pins in one of the first diametrically opposed pin patterns being rotated 180 degrees from another of the first diametrically opposed pin patterns; and
attaching a second set of pins in second diametrically opposed pin patterns of the CPU pin arrangement, the second set of pins in one of the second diametrically opposed pin patterns being rotated 180 degrees from another of the second diametrically opposed pin pattern, the first and second set of pins being mirrored.

20. The method of claim 19, wherein:
each pin includes:
a main body having a lateral asymmetric cross-section,
a first connector extending from one end of the main body, and
a second connector extending from an opposing end of the main body, the first connector terminating in a hook; and the method further comprises:
soldering the first connectors to the motherboard; and
making electrical contact between the second connectors and a CPU.
